(19) United States
(12) Patent Application Publication
(10) Pub. No.: US 2022/0317968 A1
(43) Pub. Date: Oct. 6, 2022

(54) VOICE COMMAND PROCESSING USING USER INTERFACE CONTEXT

(71) Applicant: Comcast Cable Communications, LLC, Philadelphia, PA (US)

(72) Inventors: Geoffrey Craig Murray, Bethesda, MD (US); Denys Avdieiev, Irvine, CA (US); Dallas Willis, Mullica Hill, NJ (US); David Dymit, Quakertown, PA (US); Mayur Nankani, Alexandria, VA (US); Chakradhar Chillumuntala, Philadelphia, PA (US)

(21) Appl. No.: 17/221,491

(22) Filed: Apr. 2, 2021

(51) Int. Cl. G06F 3/16; G06F 3/0482; G10L 15/183; G10L 25/51

(52) U.S. Cl. CPC G06F 3/167; G06F 3/0482; G10L 15/183; G10L 25/51

(57) ABSTRACT

Systems and methods are described herein for implementing and managing a user interface. The user interface may be controlled based on voice commands from a user. Audio data may be processed based on context information associated with the user interface to more accurately determine an intended voice command. The voice command may be used to cause an action associated with the user interface.

### BACKGROUND

Many types of devices provide playback of audiovisual content to users. In order to make a user's experience more enjoyable during playback, some of these devices may allow voice control of the playback. A voice recognition system may include a natural language processor and a library of word/command associations. However, conventional natural language processors may be limited in their ability to match translated audio to potential selectable elements, such as elements of a user interface. These and other shortcomings are identified and addressed by the disclosure.

### SUMMARY

Systems and methods are described herein for receiving, interpreting, and responding to user commands, such as voice commands, related to a user interface. The user interface may allow a user to access and navigate content, and may be controlled based on voice commands from a user. Audio data corresponding to spoken words from a user may be processed based on context information of a user interface to determine voice commands associated with the user interface. The context information may indicate the current state of a user interface for a particular user, such as a current view or what is presented by the user interface, an indication of interface elements shown on the user interface elements, and information associated with the interface elements. The context information may be used to match and filter words detected from audio data to available commands, to be matched to specific actions, such as navigating to a content page associated with content represented by a content tile, and any other action specific to the current view of the user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The following drawings show generally, by way of example, but not by way of limitation, various examples discussed in the present disclosure.

FIG. 1 shows an example system.

FIG. 2 shows a diagram of an example process.

FIG. 3 shows a diagram of example process.

FIG. 4 shows a diagram of example process.

FIG. 5 shows a flow chart of an example method.

FIG. 6 shows a flow chart of an example method.

FIG. 7 shows a flow chart of an example method.

FIG. 8 shows a flow chart of an example method.

FIG. 9 shows a flow chart of an example method.

FIG. 10A shows an example view of a user interface.

FIG. 10B shows example context information.

FIG. 10C shows an example view of a user interface.

FIG. 11A shows an example view of a user interface.

FIG. 11B shows example context information.

FIG. 11C shows an example view of a user interface.

FIG. 12A shows an example view of a user interface.

FIG. 12B shows example context information.

FIG. 12C shows an example view of a user interface.

FIG. 13 shows an example computing device for implementing any aspect of the disclosure.

### DETAILED DESCRIPTION OF ILLUSTRATIVE EMBODIMENTS

Disclosed herein are methods and systems for navigating a user interface for content using voice commands. The user interface may allow users to browse and/or otherwise access a variety of content, such as video (e.g., movies, television shows, series, live content), audio, text, social media, and applications (e.g., video games). The user interface may allow a user to navigate to an information page for a particular content item. If the content item is a series, the information page may have episodes of the series. Other content may also be indicated, such as related content with similar actors, similar genre, and/or the like. The user may navigate the user interface via a remote control. The remote control may have an audio input configured for receiving voice commands for the user interface.

Audio data received via the audio input may be processed using a voice analysis service (e.g., voice recognition process). Context information associated with the user interface may be used by the voice analysis service to determine actions to perform. Context information may comprise information associated with one or more user interface elements. The user interface elements may be interface elements currently shown on the user interface, interface elements on a page (e.g., or view) that the user is currently viewing, and/or the like. The information associated with the user interface elements may comprise actionable information (e.g., uniform resource locators, hyperlinks, button actions, function names, function parameters), text information about the content displayed on the user interface (e.g., labels, title, summary, description), and/or the like. The context information may comprise information about a visual representation of the user interface displayed on a user's screen (e.g., cursor location, scrolling location). The context information may comprise location information indicating locations of user elements in a view of the user interface (e.g., position, ordering, directionality, visual hierarchy, etc.).

The context information may be sent to the voice analysis service for use in processing audio data in a variety of ways. The voice analysis service may request the context information if a request to process audio data is received. The voice analysis service may receive the context information with the request to process the audio data. The context information may be sent to the voice analysis service from a user device rendering the user interface, from an application service (e.g., computing device, server at a different premises than the user device) in communication with the user device, a combination thereof, and/or the like.

The voice analysis service may determine (e.g., using natural language processing) one or more words from the audio data. The one or more words may be matched and/or otherwise compared to the context information. A title (e.g., label) of a content tile may match a word determined from the audio data. The voice analysis service may determine based on the matching of the one or more words that a specific user interface element is relevant to a received voice command. One or more actions associated with the user element may be determined. Additional words of the one or more words may be used to determine which of multiple actions the user is requesting. The action may have an associated word (e.g., command word), such as “info”, “play”, “navigate to,” and/or the like. The command word may be matched to the additional words. The user interface may be caused to be updated to perform the action that has been determined to match the user request.

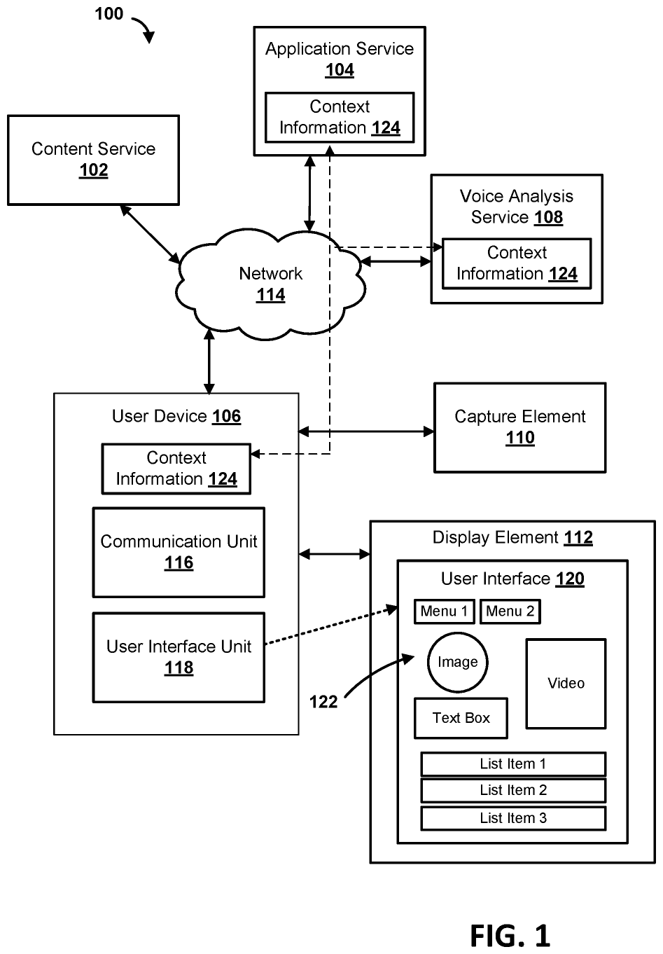

FIG. 1 is a block diagram showing an example system 100 for providing content. The system 100 may comprise a content service 102, an application service 104, a user device 106, a voice analysis service 108, a capture element 110, a display element 112, or a combination thereof. The content device 102, the application service 104, the user device 106, and the voice analysis service 108 may be communicatively coupled via a network 114 (e.g., a wide area network). The user device 106 may comprise the capture element 110 and/or the display element 112. In some scenarios, the capture element 110 and/or the display element 112 may be separate devices from the user device 106. The user device 106 may be communicatively coupled to the capture element 110 and/or display element 112 via the network, a wired connection, a cable, or another network (e.g., a local area network).

The network 114 may comprise a content distribution and/or access network. The network 114 may facilitate communication via one or more communication protocols. The network 114 may comprise fiber, cable, a combination thereof. The network 114 may comprise wired links, wireless links, a combination thereof, and/or the like. The network 114 may comprise routers, switches, nodes, gateways, servers, modems, and/or the like.

The content service 102 may be configured to send content to a plurality of users. The content may comprise video data, audio data, gaming data, closed caption (CC) data, a combination thereof, and/or the like. The content may comprise a plurality of content channels, such as live channels, streaming channels, cable channels, and/or the like. The content service 102 may comprise one or more servers. The content service 102 may be one or more edge devices of a content distribution network and/or content access network. The content service 102 may comprise a transcoder configured to encode, encrypt, compress, and/or the like the content. The content service 102 may comprise a packager configured to package the content, segment the content, and/or the like. The content device 102 may be configured to manage recorded content (e.g., schedule recordings, access recordings, etc). The content service 102 may send the content as a plurality of packets, such as transport stream packets, Moving Picture Experts Group (MPEG) transport stream packets, and/or the like.

The user device 106 may be configured to receive the content from the content service 102. The user device 106 may comprise a computing device, smart device (e.g., smart glasses, smart watch, smart phone), a mobile device, a tablet, a computing station, a laptop, a digital streaming device, a set-top box, a streaming stick, a television, and/or the like.

The user device 106 may be configured to receive the content via a communication unit 116. The communication unit 116 may comprise a modem, network interface, and/or the like configured for communication via the network 114. The communication unit 116 may be configured to communicatively couple (e.g., via a local area network, a wireless network) the user device 106 to the capture element 110, the display element 112, a combination thereof, and/or the like.

The capture element 110 may be configured to capture user input. The user input may be detected and used to generate capture data (e.g., audio data). The capture data may be sent to the user device 106, the voice analysis service 108, the application service 104, or a combination thereof. The capture element 110 may comprise an audio capture element, such as a microphone. The capture element 110 may be comprised in a remote control, in the user device 106, in a smart device (e.g., smart glasses, smart watch), a speaker, a virtual assistant device, a combination thereof, and/or the like. The capture element 110 may generate the capture data based on detection of a trigger, such as a button press, recorded audio matching a phrase or keyword, a combination thereof, and/or the like.

The user device 106 may comprise a user interface unit 118. The user interface unit 118 may comprise an application, service, and/or the like, such as a content browser. The user interface unit 118 may be configured to cause display of a user interface 120. The dotted line in FIG. 1 indicates that the user interface unit 118 may cause rendering of the example user interface 120 on the display element 112. The user interface unit 118 may receive user interface data from the application service 104. The user interface data may be processed by the user interface unit 118 to cause display of the user interface 120. The user interface 120 may be displayed on the display element 112. The display element 112 may comprise a television, screen, monitor, projector, and/or the like.

The user interface 120 may be configured to allow the user to browse, navigate, access, playback, and/or the like available content, such as content from the content service 102. The user interface 120 may allow navigation between different content channels, content items, and/or the like. The user interface 120 may comprise a plurality of interface elements 122. The plurality of interface elements 122 may comprise menu items, image elements (e.g., which cause display of an image), video elements (e.g., which control display and playback of video), text elements (e.g., which display text information), list elements (e.g., which display an order list of interface elements). The plurality of interface elements 120 may comprise actionable interface elements, such as interface elements that may be clicked or otherwise interacted with to cause an action. An interface element may comprise an image, button, dropdown menu, slide bars, or any other kind of interactive element that may be used to select content.

The user interface data received from the application service 104 may comprise data indicating the plurality of interface elements 122. The user interface data may comprise action data indicating (e.g., defining) actions, functions, and/or the like. The action data may associate the actions, functions, and/or the like with corresponding interface elements 122 and/or interface states. Actions may cause playback of content, select content, navigate to content, navigate away from content, navigate a list of content, cause information to be shown, hide information, move to another view of the user interface (e.g., from a lower menu view to a higher menu view, from a view of content to a view of related content and/or linked content), change a setting of the user interface, change a setting of an interface element (e.g., change playback mode of a video module from pause, play, stop, rewind, fast forward).

The user interface 120 may have a plurality of different interface states. The interface states may be tracked (e.g., for a user, a session, and/or a device). The interface states may be tracked by the application service 104, the user device 106, or a combination thereof Δn interface state may change if a user causes an action to be triggered, navigates the user interface, and/or the like. The interface state may comprise a current view of the user interface, a viewing history (e.g., or of different view), a location in a hierarchy (e.g., or other ordering) of interface views. An interface state may comprise a state of the current view, such as a location of a cursor, location of a selection element (e.g., showing which interface element is selected), a scrolling location, navigation location, an indication of which elements are currently displayed on the user's display, an indication of interface elements not shown on a display on a current page, a combination thereof, and/or the like.

The application service 104, the user device 106, or a combination thereof may be configured to determine context information 124. The context information may be determined by the application service 104, the user device 106, or a combination thereof. As shown by the dashed lines, the context information 124 may be stored, accessed, and/or exchanged between one or more of the application service 104, the user device 106, or the voice analysis service 108. The context information 124 may comprise the current interface state, a history of interface states, and/or the like. The context information 124 may comprise relationship information. The relationship information may comprise relationships (e.g., or associations) between the current view and other views, such as an order of the current view in a hierarchy of views. The relationship information may comprise relationships (e.g., direction, position, ordering) between the interface elements of the current view. The state information may be stored as context information 124.

The context information 124 may comprise data indicative of a content entity, such as a show, series, actor, channel, event, and/or the like. The context information 124 may comprise data indicative of a content property. The context information 124 may comprise data indicating content that a user is currently watching. The context information 124 may comprise data indicating content available (e.g., accessible) from a current view of the user interface. The context information 124 may comprise metadata associated with content, such as a content title (e.g., episode title, movie title, show title), content identifier (e.g., unique identifier for an entity, show, etc.), uniform resource identifier (e.g., link for accessing content), and/or the like.

The context information 124 may comprise data indicating one or more actions associated with a view. The one or more action may comprise purchasing, playing, pausing, fast-forwarding, rewinding, navigating, recording, scrolling, filtering, open information associated with content, sharing, a combination thereof, and/or the like. A view of the content may comprise a plurality of logical block. A logical block may comprise an ordering relative to other blocks. A logical block may comprise any of the one or more actions. A logical block may comprise a functional block, a block of code, an interface element, and/or the like. A logical block may comprise a button in the current view (e.g., with associated actions). A logical block may comprise a tile in the current view (e.g., with associated content and/or actions).

The context information 124 may be determined based on a document object model stored on the user device. The context information 124 may comprise an indication of a location of a cursor within a current view. The context information 124 may comprise a current state associated with a user, such as a location of the cursor, which interface element is highlighted, which elements are scrolled on and/or off screen, user interface state, which menu is open/active, prior states of the user, and/or the like. The state information may be stored on the user device, on a server (e.g., associated with the application service 104), a combination thereof, and/or the like.

The context information 124 may be different in different scenarios. If a current view shows a grid of tiles indicating children's movies, one of the tiles may indicate a movie titled “Up.” The context information 124 may comprise data indicating titles of all the movies shown on the tiles. A voice command that includes the term “up” may be interpreted as relevant to the movie “Up.” In a different scenario, the user may be navigating a grid of tiles indicating television shows, none of which have “up” in the title. A voice command from this second scenario that includes the term “up” may be interpreted as a command to navigate upwards from one element to another in the current view (e.g., because none of the movie titles include the term “up”). If a recognized word does not match any context information 124 (e.g., but does match a navigation command), the word may be interpreted based on a default set of commands (e.g., scrolling commands, menu commands, etc).

In another scenario, a current view of a user may show one or more movie titles, including a movie with a common name, such as “Camelot.” The content provider may provide access to several different movies with the common name. In this scenario, a content identifier associated with the specific movie shown in the current view may be used as context information 124. A voice command that includes the term “Camelot” may be interpreted as being associated with the specific movie identified by the content identifier instead of the other movies that include the same movie name but are not shown in the current view.

The context information 124 may be sent (e.g., by the user device 106, by the application service 104, or a combination thereof) to the voice analysis service 108. Capture data from the capture element 110 may be sent to the voice analysis service 108. The voice analysis service 108 may determine one or more voice command (e.g., or other result, such as an error) based on the capture data. The one or more voice commands may be determined based on the context information 124.

The voice analysis service 108 may comprise a natural language processor. The natural language processor may decompose the audio data into discrete sounds. The natural language processor may use the discrete sounds to determine one or more words, phrases, and/or other audible identifiers in the audio data. Any number of the word recognition processes may be used by the natural language processor.

The voice analysis service 108 may use the context information 124 to match the determined one or more words to corresponding voice commands, interface elements, actions, interface states, and/or a combination thereof. The context information 124 may be used to alter weights given to certain words or other audible identifiers to select corresponding voice commands, interface elements, actions, interface states, and/or a combination thereof. In some scenarios, the voice analysis service 108 may provide a list of potential translations of a voice command. Another service, such as the application service 102 may be configured to analyze the list of potential translations based on the context information 124. The context information 124 may be used to weight the potential translations. Potential translations may receive an increased weighting value based how close the translation matches the context information 124 (e.g., any values of data fields in the context information 124).

The voice analysis service 108 may send the determined voice commands, interface elements, actions, or a combination thereof as a voice analysis result to the application service 104 and/or the user device 106 (e.g., the user interface 120). The application service 104 and/or the user interface 120 may be configured to cause an update to the user interface 120 based on the voice analysis result. The update may comprise a change to a particular mode of playback of content, starting playback of a portion of content, ending playback of content, entering a trick play mode (e.g., fast forward, rewind), navigating from one view to another (e.g., from one menu to another, moving from a lower level page to an upper level page), navigating within a view, activating an interface element, moving from one interface element to another, changing a configuration setting (e.g., volume, display setting, bandwidth setting, user preference), adding text to an input element, a combination thereof, and/or the like. In some scenarios, additional clarification of a voice command may be requested. A disambiguation page may be provided with several different options, such as different action, content titles, and/or the like.

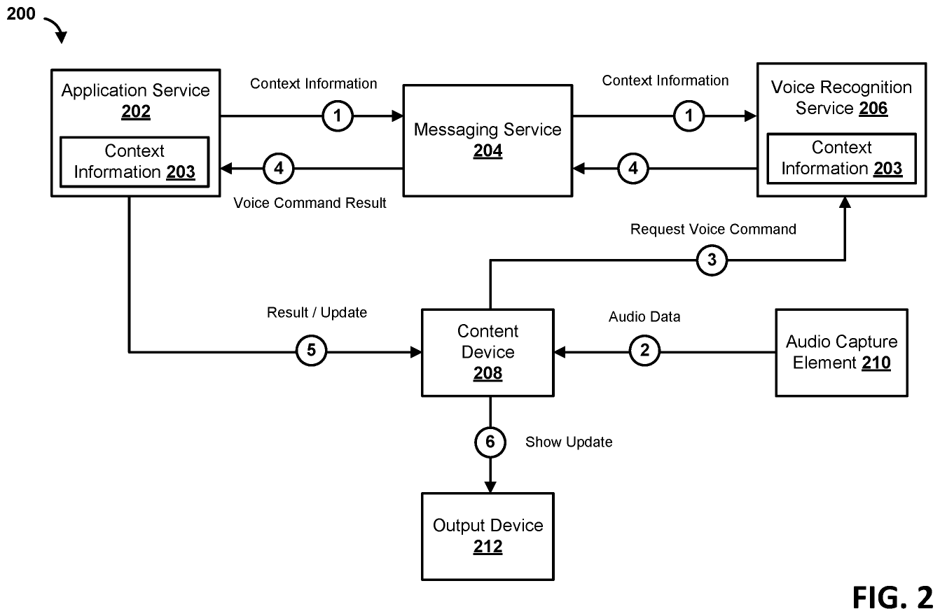

FIGS. 2-4 show diagrams of example systems and processes for implementing a user interface. The user interface may be controlled via voice commands. The voice commands may be determined by processing audio data based on context information associated with the user interface. FIGS. 2-4 show different approaches for sending the context information to a voice processing service.

FIG. 2 shows a diagram of an example system 200 for implementing a user interface. The user interface may allow users to access content, such as video, audio, text, games, and/or the like. The system 200 may allow for the use of voice commands to navigate the user interface. The system may comprise one or more of an application service 202 (e.g., application service 104 of FIG. 1), a messaging service 204, a voice recognition service 206 (e.g., voice analysis service 108 of FIG. 1), a content device 208 (e.g., the user device 106 of FIG. 1), an audio capture element 210 (e.g., the capture element 110 of FIG. 1), and an output device 212 (e.g., the display element of FIG. 1).

The application service 202 may comprise application business logic for implementing a user interface. The application service 202 may send user interface data to the content device 208, which may use the user interface data to output the user interface. The application service 202 may track a state of the user interface for corresponding users. The state of the user interface may comprise a current view (e.g., what is currently displayed on the screen to the user), interface elements of the current view, and relationship information. The relationship information may comprise relationships between the current view and other views, such as an order of the current view in a hierarchy of views. The relationship information may comprise relationship (e.g., direction, position, ordering) between the interface elements of the current view. The state information may be stored as context information 203. The context information 203 may be specific to a specific content device, session, user account, and/or the like.

At step 1, the application service 202 may send the context information 203 to the voice recognition service 206. The context information 203 may be sent via the messaging service 204. The messaging service 204 may monitor and control the transmission of messages between components of the system 220. The messaging service 204 may send data between the application service 202 and the voice recognition service 206. The context information 203 may be sent as a data stream. For a plurality of content devices, context information may be sent as one or more data streams. Each content device may have a separate data stream for sending the context information. Updates to the context information 203 may be sent as the user navigates within a view, from one view to another, a combination thereof, and/or the like.

At step 2, the audio capture element 210 may send audio data to the content device 208. The audio capture element 210 may comprise a microphone. The audio capture element 210 may be integrated into the content device or may be comprised in a separate device, such as a remote control, a phone, a personal digital assistant, a tablet, or any other device that includes a microphone for capturing audio data. The audio data may be captured in response to a user speaking, in response to the user pressing a voice command button, and/or the like.

At step 3, the content device 208 may send the audio data to the voice recognition service 206. The audio data may be sent with a request to determine a voice command based on the audio data. The voice recognition service 206 may receive audio data and process the audio data to determine a voice command result. The voice command result may comprise a voice command, an error message, and/or the like. The voice recognition service 206 may determine the voice command based on the context information 203 received from the application service 202. The voice recognition service 206 may process the context information 203 to determine a voice command associated with word, phrases, or other audible identifiers identified in audio data received.

At step 4, the content device 208 may send the voice command result to the application service 202. The voice command result may be sent via the messaging service 204. The application service 202 may determine to send the voice command result to the content device 208. In some scenarios, the application service 202 may be configured to implement the voice command result. The voice command result may be implemented by processing an action associated with the voice command result. The action may cause an update to the user interface, such as a change from the current view to another view, a change from selection of one interface element to another interface element, execution of an action associated with an interface element (e.g., loading content, playing content), and/or the like. Implementing the action may comprise causing the content device 208 to stream a particular presentation associated with the action, altering playback of the content to provide a trick play, or some other action.

At step 5, the application service 202 may send the voice command result and/or the update to the user interface to the content device 208. If the content device 208 receives a voice command result, the content device 208 may process the voice command result. The voice command result may be implemented by processing an action associated with the voice command result. The action may cause an update to the user interface, such as a change from the current view to another view, a change from selection of one interface element to another interface element, execution of an action associated with an interface element (e.g., loading content or a portion thereof, playing content, changing a playback mode), and/or the like. If the content device 208 receives an update to the user interface, then the user interface may be updated based on the update.

At step 6, data signals representing the user interface may be sent to an output device 212. The data signals may show the update to the user interface. The output device 212 may comprise a monitor, television, tablet or some other device for displaying images and/or video data on a screen.

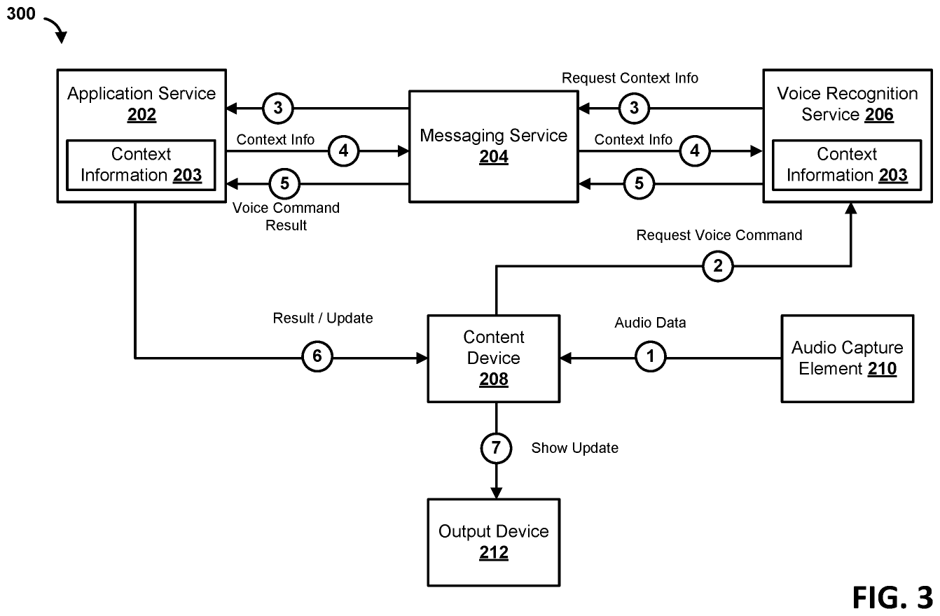

FIG. 3 shows a diagram of an example system 300 for implementing a user interface. The user interface may allow users to access content, such as video, audio, text, games, and/or the like. The system 300 may allow for the use of voice commands to navigate the user interface. The system 300 may include one or more of the components of the system 200, such as the application service 202, the messaging service 204, the voice recognition service 206, the content device 208, the audio capture element 210, and a output device 212.

The system 300 may be configured to operate according to a different process flow than the system 200 of FIG. 2. The context information 203 may be requested by the voice recognition service 206 (e.g., in an “on demand” basis, instead of being received/streamed without request). The context information 203 may be requested based on receiving audio data from the content device 208, receiving a request to determine a voice command, a combination thereof, and/or the like.

Steps 1 and 2 of FIG. 3 may proceed as described above for steps 2 and 3 of the system 200 of FIG. 2. Audio data captured by the audio capture element 210 may be sent to voice recognition service 206. At step 3, the voice recognition service 206 may send a request to the application service 202 for context information 203 associated with the content device (e.g., of a user interface displayed on the content device 208). The request may be sent via the messaging service 204. The application service 2020 may determine context information 203 associated with a current view of the user interface of the content device. At step 4, the application service 202 may send the requested context information 203 to the voice recognition service 206 (e.g., via the messaging service 204). The voice recognition service 206 may process the audio data based on the context information 203 (e.g., as in system 200, as described further elsewhere herein).

Steps 5-7 of FIG. 3 may proceed in the same manner as steps 4-6 of system 200 of FIG. 2. The voice command result may be sent to the application service 202. The voice command result may be processed by the application service to determine an update. The voice command result and/or update may be sent to the content device 208. The content device 208 may process the voice command result and/or the update. The update may be shown via the output device 212.

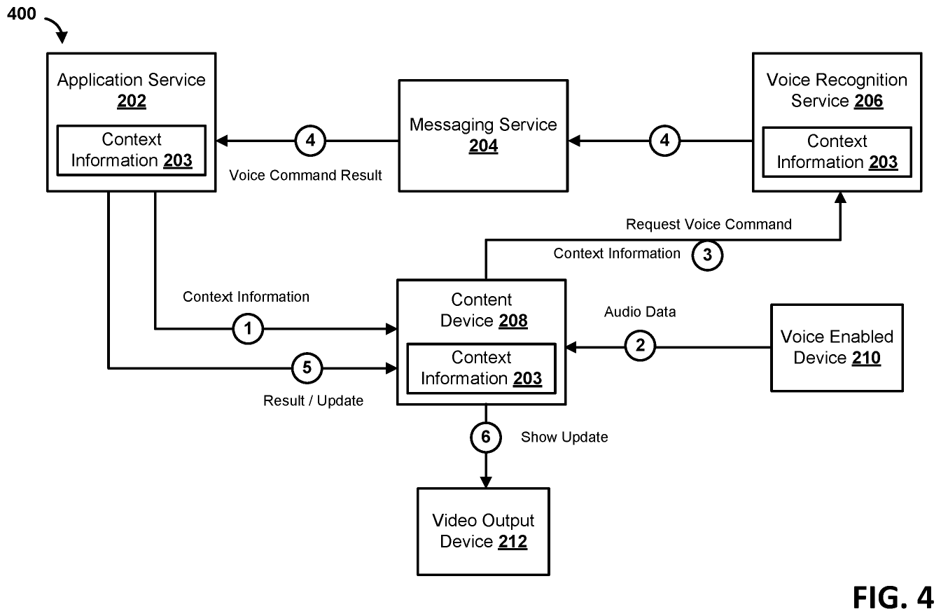

FIG. 4 shows a diagram of an example system 400 for implementing a user interface. The user interface may allow users to access content, such as video, audio, text, games, and/or the like. The system 400 may allow for the use of voice commands to navigate the user interface. The system 400 may include one or more of the components of the system 200 (e.g., or the system 300), such as the application service 202, the messaging service 204, the voice recognition service 206, the content device 208, the audio capture element 210, and a output device 212.

The system 400 may be configured to operate according to a different process flow that than the system 200 or the system 300. The application service 202 may send the context information 203 to the content device (e.g., instead of to the voice recognition service). The application service 202 may track a current user interface state associated with a user. The user interface state may be updated and/or modified as the user navigates content via the content device. In some scenarios, some or all of the context information 203 may be determined and/or generated by the content device 208 (e.g., without having the context information 203 sent from the application service 202).

At step 1, the application service 202 may send context information 203 to the content device 208. The content device 208 may store the context information 203 (e.g., until replaced by new context information). At step 2, the audio capture element 210 may send audio data to the content device (e.g., in the same manner as step 2 of system 200 of FIG. 2). At step 3, the content device 208 may send the audio data and the context information 203 to the voice recognition service 206. The voice recognition service 206 may process the audio data using the context information 203 (e.g., the same manner as the system 200 and the system 300). The voice recognition service 206 may determine a voice command result, which may comprise a voice command, an error, and/or the like.

Steps 4-6 of FIG. 4 may be performed in the same manner as steps 4-6 of the system 200 of FIG. 2. The voice command result may be sent to the application service 202. The voice command result may be processed by the application service to determine an update. The voice command result and/or update may be sent to the content device 208. The content device 208 may process the voice command result and/or the update. The update may be shown via the output device 212.

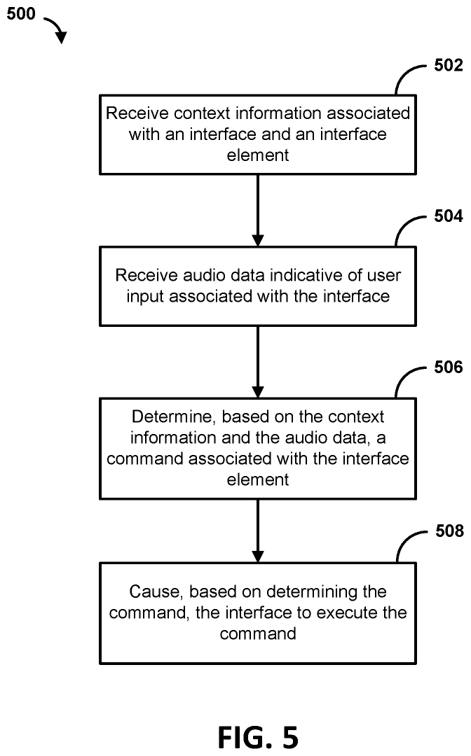

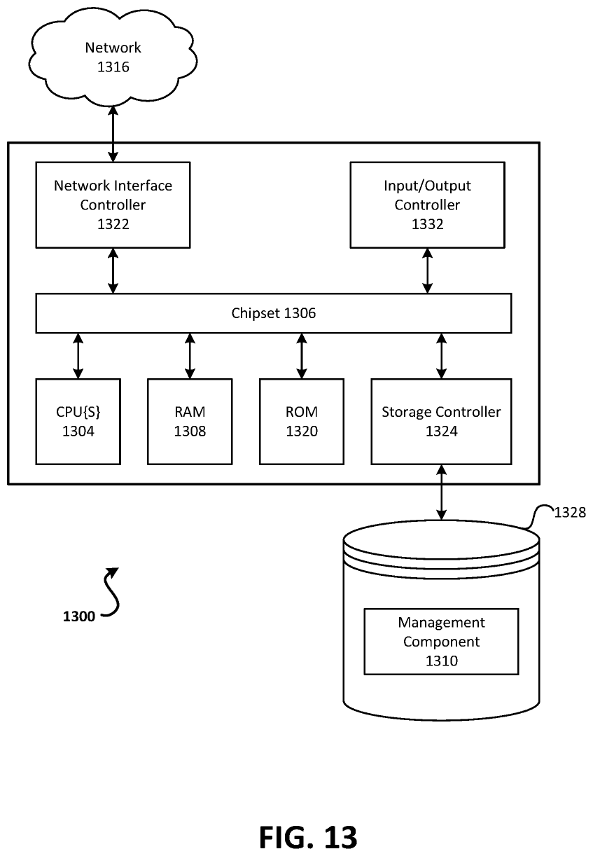

FIG. 5 is a flow chart of an example method 500. The method 500 may comprise a computer implemented method for providing a service (e.g., a content service, a content navigation service). A system and/or computing environment, such as the system 100 of FIG. 1, the system 200 of FIG. 2, the system 300 of FIG. 3, the system 400 of FIG. 4, the computing environment of FIG. 13, may be configured to perform the method 500.

A user interface (e.g., or interface, graphical interface, content interface) may be provided to a user. An application server may send data to a user device configured to output the interface. The user interface may comprise a plurality of interface elements. The plurality of interface elements may comprise one or more graphical elements, coding elements, functional elements, and/or the like. The plurality of interface elements may comprise one or more of a button, plugin, a link, a graphic, a label, a list element, a table element, a text element, menu element, submenu element, option element, and/or the like. The user interface may comprise an interface for accessing content, such as video, audio, games, and/or other information. The user interface may be implemented as a plurality of views. Each view may correspond to a different content item, content category, content group, channel, and/or the like.

At step 502, context information associated with a user interface may be received. The context information may be associated with (e.g., or indicative of) at least a portion of the plurality of interface elements. The context information may be received from a user device (e.g., a first device) that is outputting or presenting the user interface, or an associated device that is transmitting user interface information to the user device. The user device may comprise a computing device, a mobile device (e.g., a mobile phone, a laptop, a tablet), a smart device (e.g., smart glasses, a smart watch, a smart phone), a set top box, a television, a streaming device, a gateway device, digital video recorder, a vehicle media device (e.g., a dashboard console), a combination thereof, and/or the like.

The context information may be received from an application service (e.g., a second device) located external to the user device. The application service may be associated with a content service (e.g., cable service, streaming service, gaming service, audio service, video service). The context information may be received by a voice command recognition service (e.g., a third device). The voice command recognition service may be associated with the content service. The application service and/or the voice command recognition service may be implemented by one or more computing devices, servers, computing nodes (e.g., virtual machines), and/or the like.

The context information may indicate at least one interface element of the plurality of interface elements. The at least one interface element may be an interface element output via the user interface. The at least one interface element may comprise one or more of a button, plugin, a link, a graphic, a label, a list element, a table element, a text element, menu element, submenu element, option element, and/or the like. The user interface may be implemented as a plurality of views. Each view may correspond to a different content item, content category, content group, channel, and/or the like. The at least one interface element may be an element of a current view. The at least one interface element may be either shown to the user or hidden from view (e.g., if the view is only partially shown, or if the element is a hidden element).

The at least one interface element may be selectable, actionable (e.g., executable), a combination thereof, and/or the like. Selection of an interface element may comprise moving a cursor, highlight, and/or other focus element to the interface element. An interface element may be associated with an action. Activation of an interface element may comprise causing an action associated with the interface element to be performed. The action may be performed by execution of a script, computer readable code, and/or the like associated with the interface element. One of or more of the at least one interface elements may have a corresponding action.

The context information may be specific to a current view output via the user interface. The context information may indicate all of the elements of the specific view, such as the at least one interface element and/or one or more other interface elements. The context information may comprise positioning information. The positioning information may indicate one or more of a direction or a position of the at least one interface element with respect to one or more other interface elements displayed on the user interface. The positioning information may indicate a hierarchical relationship between the at least one interface element and the one or more other interface elements. The positioning information may indicate an ordering between the at least one interface element and the one or more other interface elements.

The context information may comprise and/or indicate a subset of interface elements from the user interface that are executable. The at least one interface element may be at least one of the subset of interface elements that are executable. The context information may be received based on a determination of the subset of user interface elements from the user interface that are executable. The user interface (e.g., a video rendering component) may determine the subset of user interface elements that are executable. The user interface may analyze data associated with the user interface elements and identify user interface elements that have an associated action (e.g., browse to a location, play content, navigate a menu). The context information may comprise data indicating only the user interface elements in the subset of user interface elements.

Receiving the context information associated with the user interface may comprise receiving, based on a user navigating to a view of the user interface, the context information. Updated context information may be received each time a user navigates to a new interface state (e.g., new view, or change within a view). If the interface is providing a view of a content item, the context information may comprise an indication of one or more buttons associated with the content item, such as a play button, an episodes button, a record button, a reminder button, a more information button. The indication of the one or more buttons may comprise titles (e.g., or name) of each button, an action associated with the button, a combination thereof, and/or the like.

At step 504, audio data indicative of user input associated with the user interface may be received. The audio data may be received from the user device. The user device may capture the audio data using a microphone. The user device may receive the audio data from a separate device, such as a remote control. The audio data may be captured as input for a voice command. The audio data may be captured based on recognition of a keyword (e.g., or phrase), a gesture by a user (e.g., picking up a device), pressing a button, and/or the like.

At step 506, a command (e.g., interface command, user command, navigation command) associated with an interface element of the plurality of interface elements may be determined. The interface element may be one of the at least one interface element. The command may be determined based on, at least in part and in addition to other factors, the context information and the audio data. Determining the command may comprise translating the audio data to text information. The command may be determined based on the context information and the text information. The text information may be compared to the context information. One or more potential translations of the audio data in the text information may be compared to text information in the context data. The text information may comprise labels, text, and/or the like associated with interface elements. The positioning information may be used to determine the interface command. The position, direction, hierarchical relationship, ordering, and/or other positioning information may be used to determine the interface command. The current position of the cursor, currently selected interface element, and/or other information may be used to determine the interface command.

A user may be on a content page of a movie. The content page may have a section of the page entitled “cast & crew” that provides images of different actors that can be clicked on to view more info. The user may say “show me more information about Harrison Ford.” The context information may include data indicating all the interface elements, such as elements for each actor, a play element, a trailer element, a rent/buy element, and/or the like. The text information for each element in the context information may be compared to preliminary text translation of the audio. It may be determined that the preliminary text translation matches (e.g., has a highest ranking match), with the text information associated with the interface element for navigating to the Harrison Ford page. The other translated text “show me more” may be recognized as text associated with navigating to another page. The link associated with the Harrison Ford element may be determined based on its associated with the matching interface element.

At step 508, the user interface may be caused to execute the command (e.g., or action). The user interface may be caused, based on determining the command, to execute the command. The command may comprise one or more actions (e.g., functions), parameters associated with actions (e.g., settings, link to navigate to, amount associated with an action), and/or the like. The command may comprise a command to one or more of access content indicated on the user interface, navigate from the interface element to an additional interface element, activate the interface element, or navigate from one view of the user interface to additional view of the user interface.

Returning to the Harrison Ford example, the user interface may be caused to navigate to a link that was stored in the context information. The link may be the link associated with the matching interface element (e.g., which had the Harrison Ford text information). The link may be identified as an action. If more than one actions are identified in the context information for the interface element. The “show me information” may be used to determine which action is intended. Key words, such as “play, show, information, navigate, go back, quit,” and/or the like, may be associated with different types of actions stored in the context information. These keyword may be searched in the translated text from audio to determine which keyword or set of keywords matches closest. Based on the “show in information,” the keywords show and/or information may be matched to an “information” or “info” or other similar action. The info action may be identified data associated with the interface element. A link in the info action field may be identified, and the user interface may be caused to navigate to the link (e.g., thereby updating the user interface).

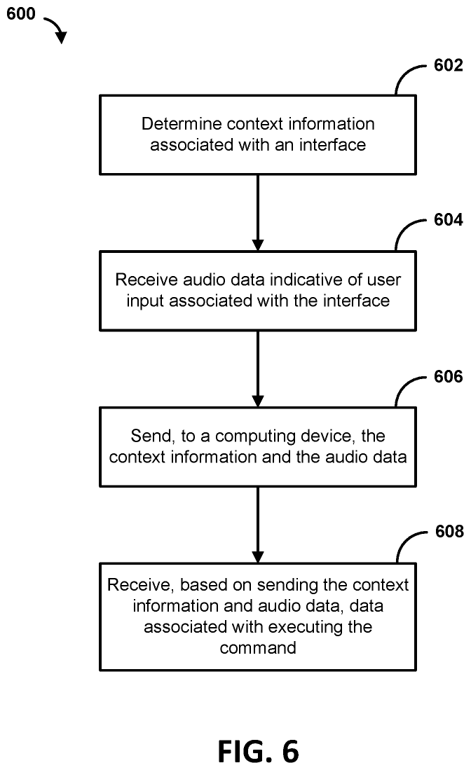

FIG. 6 is a flow chart of an example method 600. The method 600 may comprise a computer implemented method for providing a content service (e.g., a content navigation service). A system and/or computing environment, such as the system 100 of FIG. 1, the system 200 of FIG. 2, the system 300 of FIG. 3, the system 400 of FIG. 4, the computing environment of FIG. 13, may be configured to perform the method 600.

A user interface (e.g., or interface, graphical interface, content interface) may be provided to a user. An application server may send data to a user device configured to output the interface. The user interface may comprise a plurality of interface elements. The plurality of interface elements may comprise one or more graphical elements, coding elements, functional elements, and/or the like. The plurality of interface elements may comprise one or more of a button, plugin, a link, a graphic, a label, a list element, a table element, a text element, menu element, submenu element, option element, and/or the like. The user interface may comprise an interface for accessing content, such as video, audio, games, and/or other information. The user interface may be implemented as a plurality of views. Each view may correspond to a different content item, content category, content group, channel, and/or the like.

At step 602, context information may be determined. The context information may be associated with the user interface and/or at least one of the plurality of interface elements. The context information may be determined by a user device (e.g., a first device) outputting the user interface. The user device may comprise a computing device, a mobile device (e.g., a mobile phone, a laptop, a tablet), a smart device (e.g., smart glasses, a smart watch, a smart phone), a set top box, a television, a streaming device, a gateway device, digital video recorder, a vehicle media device (e.g., a dashboard console), a combination thereof, and/or the like. Determining the context information may comprise determining (e.g., or generating) the context information based on user interface data used to generate the user interface. The user interface data may be received by an application service located external to the user device (e.g., a second device). The context information may be received from the application service. The application service may be associated with a content service (e.g., cable service, streaming service, gaming service, audio service, video service).

The context information may indicate the at least one interface element. The at least one interface element may be an interface element output via the user interface. The at least one interface element may comprise one or more of a button, plugin, a link, a graphic, a label, a list element, a table element, a text element, menu element, submenu element, option element, and/or the like. The context information may be specific to a current view output via the user interface. The context information may indicate one or more of a direction or a position of the interface element with respect to one or more other interface elements displayed on the user interface. Receiving the context information may comprise receiving the context information from one or more of a user device outputting the user interface or an application service located external to the user device.

Determining the context information may comprise determining a subset of the plurality interface elements (e.g., which are in a current view or page) of the user interface that are executable. The user device (e.g., or user interface, rendering component of the user interface) may be configured to determine a subset of the plurality interface elements of the user interface that are executable. The user interface may analyze data associated with the user interface elements and identify user interface elements that have an associated action (e.g., browse to a location, play content, navigate a menu). The executable interface elements may be determined based on action fields indicating actions to perform associated with an interface element. The executable interface elements may be determined based on functions associated with the user interface elements in a script language. A predetermined list of functions identified as executable functions may be matched to the functions associated with the user interface elements. The context information may comprise data indicating only the user interface elements of the user interface that are in the subset of user interface elements.

At step 604, audio data indicative of user input associated with the user interface may be received. The audio data may be received by the user device. The user device may capture the audio data using a microphone. The user device may receive the audio data from a separate device, such as a remote control. The audio data may be captured as input for a voice command. The audio data may be captured based on recognition of a keyword (e.g., or phrase), a gesture by a user (e.g., picking up a device), pressing a button, and/or the like.

At step 606, the context information and the audio data may be sent (e.g., via a network) to a computing device (e.g., the third device). The computing device may comprise a voice command recognition service. The voice command recognition service may be associated with the content service. The application service and/or the voice command recognition service may be implemented by one or more computing devices, servers, computing nodes (e.g., virtual machines), and/or the like.

The computing device may be configured to determine, based on the context information and the audio data, a command (e.g., or result of voice analysis) associated with an interface element of the plurality of interface elements. The interface element may be one of the at least one interface elements. The command may comprise an interface command, navigation command, browsing command, and/or any action associated with the user interface. The computing device may determine the interface command based on the subset of user interface elements that are determined to be executable. The command may be determined based on translating the audio data to text information. The command may be based on the context information and the text information. The command may comprise one or more actions (e.g., functions), parameters associated with actions (e.g., settings, link to navigate to, amount associated with an action), and/or the like. The text information may be compared to data associated with the subset of user interface to determine if any words in the text information match any user interface elements in the subset.

At step 608, data associated with executing the command (e.g., an action associated with the user interface) may be received. The data associated with executing the command may be received based on the sending the context information (e.g., and/or sending the audio data). The command may comprise a command to one or more of access content indicated on the user interface, navigate from the interface element to an additional interface element, activate the interface element, or navigate from one view of the user interface to additional view of the user interface.

The context information may comprise a list of interface elements (e.g., buttons) currently shown to the user via the user interface. The context information may comprise data associated with each interface element, such as title, text shown to user associated with (e.g., on, next to) the interface element, an action, a link to cause execution of an action, and/or the like. The audio data may be processed to determine several potential translations of the audio to text. The resulting text may be compared to the context information. The text may be compared to each of the titles (e.g., or text associated with the interface element). If there is a match between the text and the title, then a link reference an action may be identified by identifying other information associated with the matching interface element.

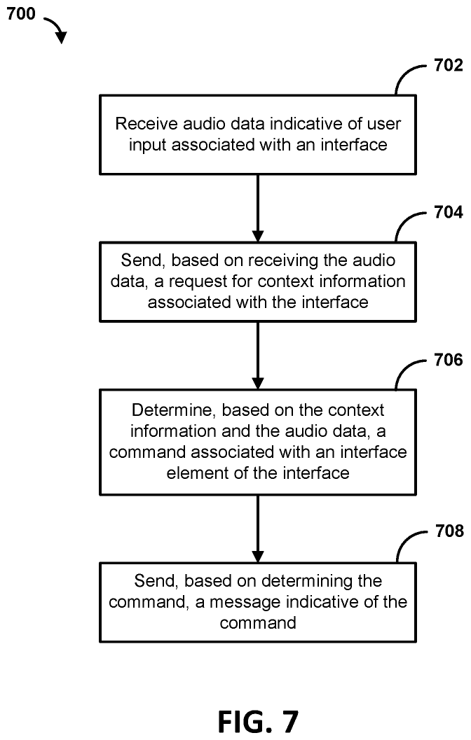

FIG. 7 is a flow chart of an example method 700. The method 700 may comprise a computer implemented method for providing a content service (e.g., a content navigation service). A system and/or computing environment, such as the system 100 of FIG. 1, the system 200 of FIG. 2, the system 300 of FIG. 3, the system 400 of FIG. 4, the computing environment of FIG. 13, may be configured to perform the method 700. The method may relate to one or more computing device, such as a first device, a second device, and a third device.

At step 702, audio data indicative of user input associated with a user interface (e.g., or interface, content interface) may be received. The audio data may be received by a voice recognition service (e.g., third device). The audio data may be captured by a user device (e.g., first device) may using a microphone. The user device may receive the audio data from a separate device, such as a remote control. The audio data may be captured as input for a voice command. The audio data may be captured based on recognition of a keyword (e.g., or phrase), a gesture by a user (e.g., picking up a device), pressing a button, and/or the like.

At step 704, a request for context information associated with the user interface may be sent (e.g., by the third device). The voice recognition service may send the request to an application service (e.g., the second device). The request for context information may be sent based on receiving the audio data. The context information may be specific to a current view output via the user interface. The context information may indicate one or more of a direction or a position of the interface element with respect to one or more other interface elements displayed on the user interface. The context information may be received from an application service associated with the user interface and based on the request.

The context information may comprise a subset of interface elements from the user interface that are executable. The subset of interface elements may comprise the interface element associated with the interface command. The voice recognition service may determine the subset from the context information. The device processing the request may determine the subset and send data indicating only the user interface elements of the user interface that are in the subset of user interface elements. Data associated with the user interface elements may be analyzed to identify user interface elements that have an associated action (e.g., browse to a location, play content, navigate a menu). The executable interface elements may be determined based on action fields indication actions to perform associated with an interface element. The executable interface elements may be determined based on functions associated with the user interface elements in a script language. A predetermined list of functions identified as executable functions may be matched to the functions associated with the user interface elements.

At step 706, an interface command (e.g., or command, user command, navigation command, browsing command) associated with an interface element of the user interface may be determined (e.g., by the third device). The interface command may be determined based on the context information and the audio data. Determining the interface command may comprise translating the audio data to text information. The interface command may be determined based on the context information and the text information. The interface command may comprise one or more actions (e.g., functions), parameters with associated actions (e.g., settings, link to navigate to, amount associated with an action), and/or the like.

At step 708, a message indicative of the interface command may be sent (e.g., by the third device, to the first device and/or second device). The message indicative of the interface command may be sent based on determining the interface command. The user interface may be caused, based on the message, to execute the interface command (e.g., an action associated with the interface element). The interface command may comprise a command to one or more of access content indicated on the user interface, navigate from the interface element to an additional interface element, activate the interface element, or navigate from one view of the user interface to additional view of the user interface.

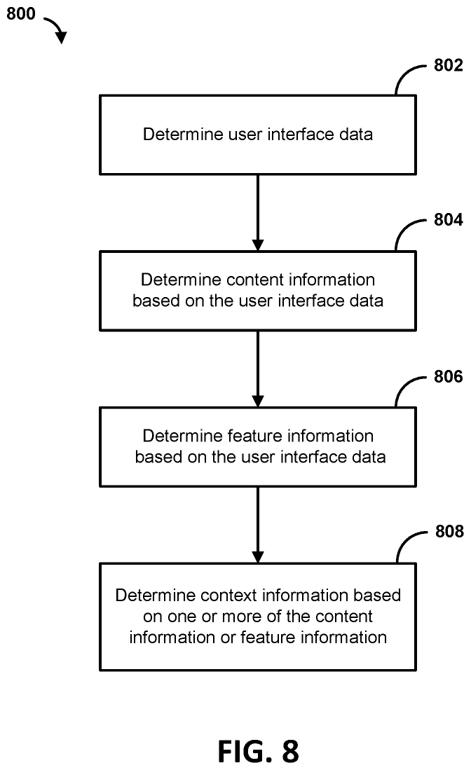

FIG. 8 shows a flow chart of an example method for generating context information. The context information may be specific to a particular user interface, such as one associated with a particular user account, executing on a particular device, and/or the like. The context information may relate to a specific view of the user interface. The view may comprise the output shown to the user on a display. The view may be a rendering of view data that causes the view to be displayed. The steps below may be performed by an application, an application service, a computing device (e.g., server, computing node) external to a user premises, a content device located at the premises, a combination thereof, and/or the like.

At step 802, user interface data may be determined. The user interface data may be determined (e.g., received, accessed, generated) by an application, an application service, a server external to a user premises, a content device located at the premises, and/or the like. The display information may include content information and feature information.

### The User Interface Data

At step 804, content information may be determined based on the user interface data. The content information may comprise an indication of one or more interface elements that comprise content. The interface elements that comprise content may comprise an image, a playback module, video, and/or the like. The content information may comprise a title associated with a user interface element. The title may indicate a title associated with a group of content, a name of a content item, and/or the like. The content information may comprise a uniform resource identifier (e.g., link) for navigating to a content information page, a group of content (e.g., content row), and/or the like. The content information may comprise location information indicating locations of corresponding interface elements (e.g., as displayed via the user interface). The location information may indicate a physical location (e.g., location in a reference system of a content page), a virtual location (e.g., heading, tag location), a navigable location (e.g., link), and/or the like. The content information may comprise relationship information indication relationships (e.g., ordering, direction) between the interface elements.

At step 806, feature information may be determined based on the user interface data. The feature information may comprise actions (e.g., or script functions or names to access the action) associated with the user interface. An example action may comprise a playback control actions (e.g., or functions), content selection actions (e.g., or functions), actions associated with activating (e.g., clicking on, hovering on, pressing enter on) user interface elements, navigation actions (e.g., scroll down, navigate to page associated with a user interface element), and/or the like.

At step 808, the context information may be determined based upon the content information, the feature information, and/or a combination thereof. The context information may be stored in a data structure. The context information may comprise data elements (e.g., data entries, hierarchical data, data organized as fields and values) corresponding to each user interface element, group of user interface elements, and/or the like. Data elements for a user interface element may comprise a name (e.g., title), type of data element (e.g., button, tile, menu, etc.). Data elements for the user interface element may comprise a list of one or actions that may be triggered for a particular user interface element. The actions may change a state of the user interface element, cause navigation to a location associated with the user interface element, and/or the like. The data elements may indicate a location of the user interface element, associated metadata (e.g., tags, categories), and/or the like.

The following figures provided examples that are used for purposes of illustration. It should be understood that the disclosure is not limited to the following example, but the examples are only used to illustrate the aspects of the disclosure.

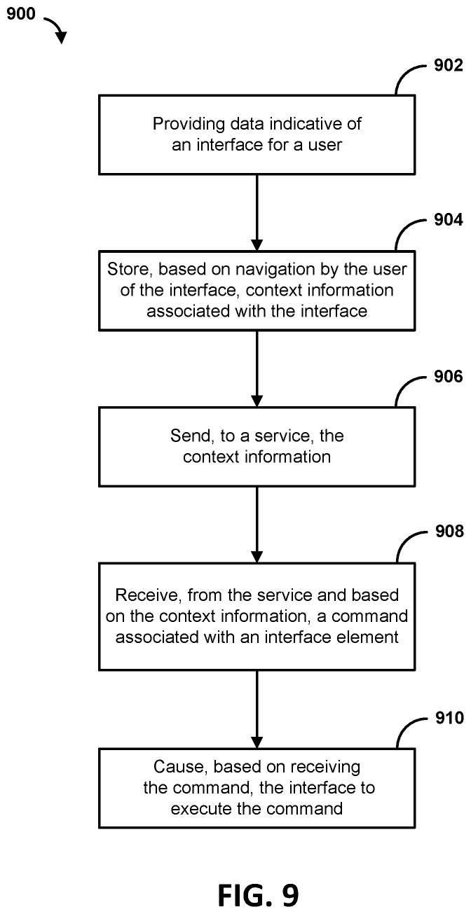

FIG. 9 is a flow chart of an example method 900. The method 900 may comprise a computer implemented method for providing a service (e.g., content service, a content navigation service). A system and/or computing environment, such as the system 100 of FIG. 1, the system 200 of FIG. 2, the system 300 of FIG. 3, the system 400 of FIG. 4, the computing environment of FIG. 13, may be configured to perform the method 900. The method may relate to one or more computing device, such as a first device, a second device, and a third device.

At step 902, data indicative of an interface for a user may be provided. The data indicative of the interface may be provided by a server device (e.g., or first service, first device, application service, application server). The interface may comprise a plurality of interface elements. The data indicative of the interface may comprise data specific to a user and/or session (e.g., each user accessing the interface may have a separate session with different corresponding context information). The interface may comprise a plurality of views, such as a content browser with corresponding pages, menus, views, and/or the like. If a user begins navigating the content browser, the user device may send a request for data to the server device. The server device may send the data indicative of the interface as a data page and/or other resource (e.g., data record, structured data). The data indicative of the interface may indicate the interface elements, properties thereof, locations thereof, relationships thereof, and/or the like.

At step 904, context information may be stored (e.g., by the server device, the first device, a storage device). The server device may cause the context information to be stored in a storage device and/or in storage managed by the server device. The context information may be associated with the interface (e.g., an association of the context information with an instance of the interface associated with a user and/or session may be stored). The context information may be associated with the plurality of interface elements (e.g., an association of the plurality of elements with the instance of the interface may be stored). The context information may be stored based on navigation by the user of the interface (e.g., each time the user performs a navigation action, the context information may be update to reflect the current interface state, interface view, interface page, and/or the like). Storing the context information may comprise one or more of tracking interactions of the user with the interface, storing a current state of the interface, or storing changes to the user interface.

The context information may indicate at least one interface element output via the user interface. The context information may include data indicating only interface elements currently displayed to the user (e.g., excluding areas that are scrolled out of view in the viewers screen). The at least one interface element may comprise one or more of a button, plugin, a link, a graphic, a label, a list element, a table element, a text element, menu element, submenu element, option element, and/or the like. The context information may be specific to a current view output via the user interface. The context information may indicate one or more of a direction or a position of the interface element with respect to one or more other interface elements displayed on the user interface. Receiving the context information may comprise receiving the context information from one or more of a user device outputting the user interface or an application service located external to the user device.

The context information may comprise a subset of the plurality of interface elements (e.g., which are in a current view or page) from the interface that are executable. The subset of interface elements may comprise the interface element associated with the interface command. The context information may be specific to (e.g., or indicative of) a current view output via the interface. The server device (e.g., or application service, application server) may be configured to determine the subset of the plurality interface elements of the user interface that are executable. The interface may analyze data associated with plurality of the interface elements and identify user interface elements that have an associated action (e.g., browse to a location, play content, navigate a menu). The executable interface elements may be determined based on action fields indicating actions to perform associated with an interface element. The executable interface elements may be determined based on functions associated with the user interface elements in a script language. A predetermined list of functions identified as executable functions may be matched to the functions associated with the user interface elements. The context information may comprise data indicating only the user interface elements of the user interface that are in the subset of user interface elements.

If a user navigates to a page, the context information may be updated for a session associated with the user. If the user navigates to a menu for browsing content, the context information may have an indication (e.g., a list, other data structure, object structure, markup structure) of sections and/or an indication of content tiles (e.g., within each section). The context information may be hierarchical. A section of the interface may have its own corresponding section in the context information. Within the section in the context information, one or more content tiles may be indicated. A content tile may have a subsection of data corresponding to the content tile (e.g., text information, actions). If only a part of page is shown to the user, then only the part shown may be stored as context information. As the user browses the page, displaying new and/or hiding content tiles, then the context information may be further updated.

At step 906, the context information may be sent (e.g., by the first device). The context information may be sent to a service (e.g., or a second device). The service (e.g., or second device) may comprise an audio processing service. The context information may be sent to the service based on (e.g., in response) on a request received from the service. The service may receive audio data from the user device. The receiving of the audio data by the service may cause the request to be sent to the first device. In another implementation, the audio data may be received by the first device. The first device may send the context information with the audio data to the service (e.g., based on receiving the audio data).

At step 908, a command associated with an interface element may be received (e.g., by the first device). The command may be received from the second device, audio processing service, a combination thereof, and/or the like. The command may be received based on context information. The second device (e.g., or second service, audio processing service) may be configured to determine, based at least in part on the context information and audio data associated with the interface, the command associated with the interface element. The second device (e.g., or second service, audio processing service) may receive the audio data from a third device. The third device may comprise a user device associated with the user. The second device (e.g., or service, audio processing service) may be configured to translate the audio data to text information. The second device (e.g., or service, audio processing service) may be configured to determine, based on the context information and the text information, the interface command.

The command may comprise a command to one or more of access content indicated on the interface, navigate from the interface element to an additional interface element, activate the interface element, or navigate from one view of the user interface to additional view of the user interface. A user may say “return to main page” while on a page for a specific content item. The context information may include text information for interface elements on the page. The words “main” and/or “page” may be compared to the text information for each element in the context information. The context information may also comprise a location of the page in a menu hierarchy and/or browsing history. If the menu hierarchy and/or browsing history in the context information may be searched to determine that main page refers to the main content browsing page one level up in the menu hierarchy. The context information may comprise a link to navigate back to the main page. The identified command may comprise a command to navigate via the link back to the main page.

At step 910, the interface may be caused to execute the command. The interface may be caused, based on recieving the commend, to execute the command. The first device may send data indicative of the command to the user device. The third device may execute the command. The third device may request navigation to the main back by navigating via the link. In some implementations, the first device may cause the user interface to be navigated to the link without sending the command to the user device.

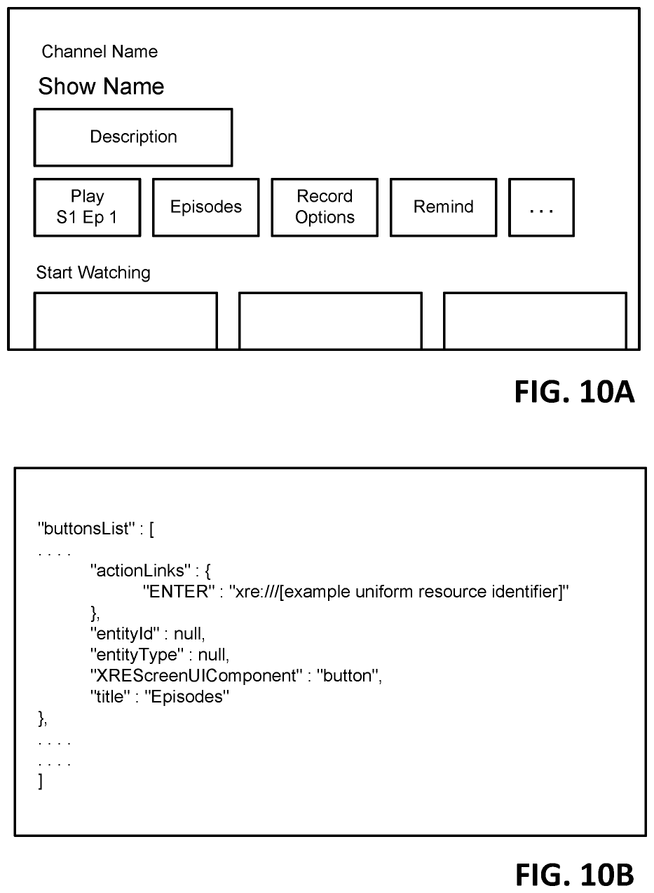

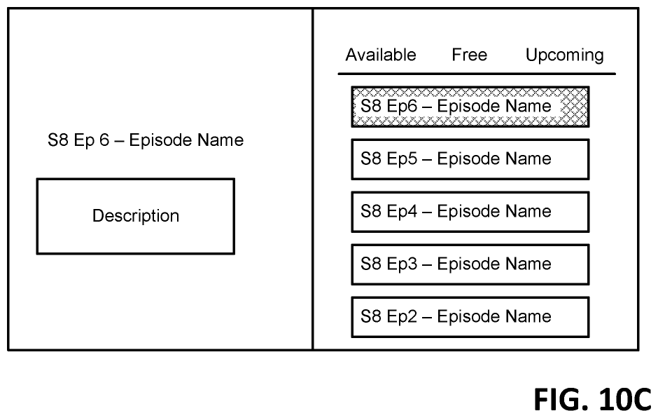

FIG. 10A shows an example view of an example user interface. A user may access the user interface via a user device, such as the user device 106 shown in FIG. 1. The user interface may show an information view associated with a content entity, such as a television show. The user interface may comprise user interface elements, such as buttons (e.g. play button, episode button, record button, remind button), content tiles (e.g., for accessing different episodes, and/or the like. The user may say a name (e.g., or title, label) associated with a selectable user interface element, such as a button, a content title, menu item. The user may say “Episodes” while on the information view. The user interface (e.g., or computing device executing the user interface) may detect that audio data indicative of user input is received. Context information associated with the information view may be determined (e.g., by the user interface, device associated with the user interface). The context information may comprise information associated with the buttons, content tiles, rows, icons, option selectors, option elements, action bar items, menu element, submenu element, filter element, and/or the like. The context information may comprise a link (e.g., hyperlink, deeplink to specific content), identifier, title, identifier, and/or the like for each user interface element.

FIG. 10B shows example context information associated with the information view of FIG. 10A. The example context information may comprise context information for the “Episodes” button of the information view. The context information may comprise a plurality fields and corresponding values. The context information may comprise a field (e.g., “actionLinks”) indicating actions associated with the user element. The actions may comprise an enter action, click, hover, and/or other action. The action may be performed by accessing a uniform resource identifier (e.g., link) associated with the command. FIG. 10B shows the uniform resource identifiers as “[example uniform resource identifier].” It should be understood that any combination of symbols, characters, numbers, words, protocols, domains, and/or the like may be used in place of any example uniform resource identifier shown in the figures herein. As shown in the example, an “enter” action is associated with a corresponding link for accessing a page that indicates episodes of the show. The context information may comprise an entity identifier field (e.g., “entityID”) that indicates an identifier associated with an entity (e.g., if the user interface element is associated with an entity). An entity may comprise a content item, such as a show, episode of a show, series, and/or the like. The context information may comprise an entity type field (e.g., “entityType”) indicating a type of the entity (e.g., tv show, tv series, movie, recording, etc.). The plurality of fields may comprise an interface element type field (e.g., “XREScreenUIComponent”) indicating a type of interface element (e.g., button, text box, picture, icon, menu, submenu, option element, option selector element) associated with an interface element. The context information may comprise a title field indicating a title of the user interface element.

The context information may be sent to the voice analysis service 108 of FIG. 1. The voice analysis service 108 may analyze the audio data to determine that the user has requested that the episodes button be executed and/or triggered. The voice analysis service 108 may recognize the word “episodes” using natural language processing. The context information may be searched (e.g., the recognized word may be compared to each of the values of the title fields). If the voice analysis service 108 matches the word to a title field value associated with the episodes button, the voice analysis service 108 may access the one or more of actions (e.g., “actionLinks”) associated with the same interface element as the title (e.g., in the context information) to determine any actions associated with the button. The “enter” action may be determined and the associated link may be processed. The link may be used to cause an update to the user interface to display a user interface view associated with the link. FIG. 10C shows an example updated view of the user interface. The updated view shows an example episodes view navigated to based on the voice command selecting the episodes button. Crosshatching indicates which episode is selected in the user interface.

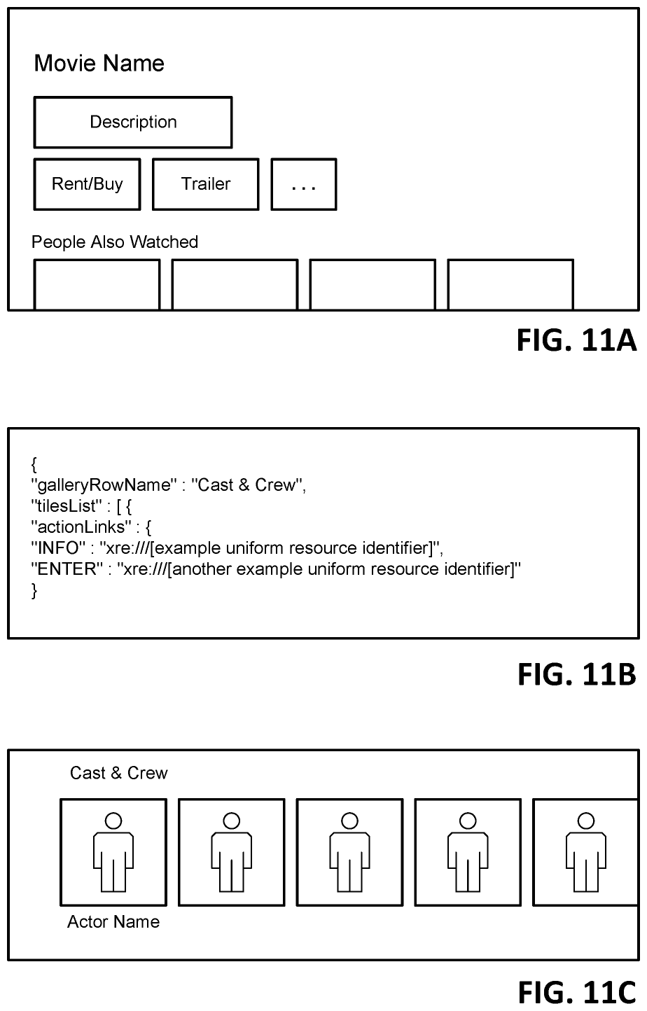

FIG. 11A shows an example information view of a user interface. The information view may show information for a movie. The information view may comprise a plurality of user interface elements, such as text elements (e.g., description of the movie), buttons (e.g., rent/buy, trailer), content tiles (e.g., tiles show similar movies). A user accessing the example information view may speak the words “cast and crew.” The user interface may detect that audio data indicative of user input is received. Context information associated with the information view may be determined (e.g., by the user interface, device associated with the user interface). The context information may comprise information associated with the buttons, content tiles, and/or the like. The context information may comprise a link (e.g., hyperlink, deeplink to specific content), one or more actions, identifier, title, identifier, and/or the like for each user interface element.

The context information may comprise information associated with a row (e.g., gallery row) associated with the view of the user interface. FIG. 11A shows a “People Also Watched” row with associated content tiles. Additional rows may be scrolled to below this row, such as a “Cast & Crew” row that comprises information about the cast and crew of the movie. The context information may include information for each row and/or content tile (e.g., whether shown in the screen or not).

FIG. 11B shows example context information associated with a row. The context information may comprise one or more of a row name (e.g., “galleryRowName”), a list of tiles (e.g., “tilesList”), one or more action (e.g., “actionLinks”), and/or the like. The One or more actions may comprise an information action (e.g., “INFO”) associated with a link for accessing information. The one or more actions may comprise an enter action (e.g., “ENTER”) associated with navigating to the associated row (e.g., within the current page) and/or a page comprising the row.

The context information may be sent to the voice analysis service 108 of FIG. 1. The voice analysis service 108 may analyze the audio data to determine that the user has requested to navigate to a Cast & Crew row (e.g., or page). The voice analysis service 108 may recognize the words “cast” and “crew” using natural language processing.

The context information may be searched (e.g., the recognized words may be compared to each of the values of the title fields). If the voice analysis service 108 matches the recognized words to the title of the “Casts & Crew” row, the voice analysis service 108 may access the one or more of actions (e.g., “actionLinks”) associated with the row. The “enter” action may be determined and the associated link may be processed. The link may be sent to one or more of the application service 104, the user device 106. The link may be used to cause the user interface to navigate to the Casts & Crew row. FIG. 11C shows an example updated view of the user interface. The updated view shows the Casts & Crew row associated with the movie.

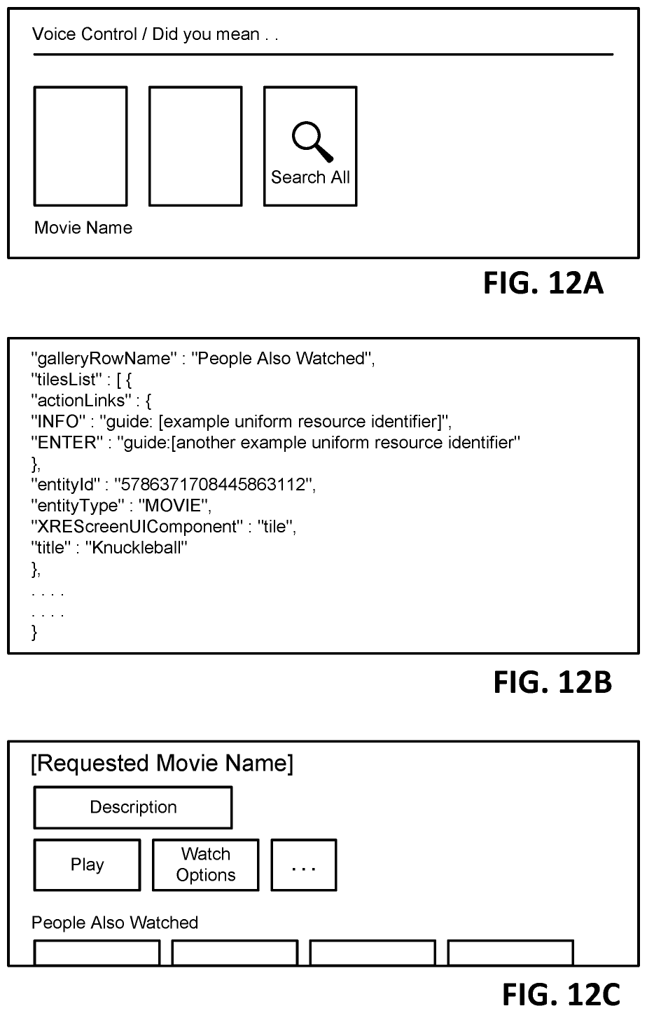

FIG. 12A shows an example voice command view of a user interface. The voice command view may be a view for performing disambiguation. The voice command view may be used if there is not any matching context information to assist in processing the voice command. The voice command view may be launched if the user provides a video command during full screen video playback, while on an information screen not associated with a content item, and/or the like. A user may give a voice command comprising words of a movie name. The audio data associated with the voice command may be sent to the voice analysis service 108. The voice analysis service 108 may have multiple results (e.g., that are weighted similarly). Multiple movies accessible via the user interface may have names that include the words recognized from the audio data. The voice analysis service 108 may cause an update to the user interface. The update may comprise a plurality of different content items (e.g., movies) that match the words recognized from the audio date. The user may select the content tile that corresponds to the requested content.

FIG. 12B shows example context information. A user may also request a movie from a view associated with another movie. The user interface may have a row of content tiles (e.g., “People Also Watched” row) indicating additional movies relevant to the movie which is displayed on the user interface. The user may speak the name of another movie shown in the row. The user interface may receive audio data associated with the voice command. The user interface (e.g., or user device, server) may determine context information associated with the current view of the user interface. Example context information is shown in FIG. 12B and includes actions (e.g., “actionLinks”), a content identifier (e.g., “entityID”), a content type (e.g., “entity type”), an indication of user interface element type (e.g., “XREScreenUIComponent”), a movie name (e.g., “title”). The context information may be determined for each content tile shown in the row. The context information may be used to process the audio data, and/or determine a command based on the processed audio data.

The audio data associated with the voice command may be sent to the voice analysis service 108. The voice analysis service 108 may use context information to determine a link to navigate to. One or more recognized words from the audio data may match the title field associated with a particular content tile. If the user says “info” the info action command may be selected from the context information associated with the tile. If the user says one or more words associated with navigating to the content, the enter action command may be selected from the context information associated with the tile. The selected command may be translated, packaged, processed, and/or the like to cause the command to be executed at the user interface (e.g., causing navigation to the link associated with the command). The command may be processed by causing the user interface to navigate to a link associated with the command. FIG. 12C shows an example updated user interface view corresponding to the movie requested by the user via the voice command.

FIG. 13 depicts a computing device that may be used in various aspects, such as the services, servers, modules, and/or devices depicted in FIGS. 1-4. With regard to the example architecture of FIG. 1, the content device 102, application service 104, user device 106, voice analysis service 108, display element 112, and/or capture element may each be implemented in an instance of a computing device 1300 of FIG. 13. With regard to the example architecture of FIGS. 2-4, the application service 202, messaging service 204, voice recognition service 206, content device 208, audio capture element 210, and/or output device 212 may each be implemented in an instance of a computing device 1300 of FIG. 13. The computer architecture shown in FIG. 13 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 1-12.

The computing device 1300 may include a baseboard, or “motherboard,” which is a printed circuit board to which a multitude of components or devices may be connected by way of a system bus or other electrical communication paths. One or more central processing units (CPUs) 1304 may operate in conjunction with a chipset 1306. The CPU(s) 1304 may be standard programmable processors that perform arithmetic and logical operations necessary for the operation of the computing device 1300.

The CPU(s) 1304 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1304 may be augmented with or replaced by other processing units, such as GPU(s) 1305. The GPU(s) 1305 may comprise processing units specialized for but not necessarily limited to highly parallel computations, such as graphics and other visualization-related processing.

A chipset 1306 may provide an interface between the CPU(s) 1304 and the remainder of the components and devices on the baseboard. The chipset 1306 may provide an interface to a random access memory (RAM) 1308 used as the main memory in the computing device 1300. The chipset 1306 may further provide an interface to a computer-readable storage medium, such as a read-only memory (ROM) 1320 or non-volatile RAM (NVRAM) (not shown), for storing basic routines that may help to start up the computing device 1300 and to transfer information between the various components and devices. ROM 1320 or NVRAM may also store other software components necessary for the operation of the computing device 1300 in accordance with the aspects described herein.

The computing device 1300 may operate in a networked environment using logical connections to remote computing nodes and computer systems through local area network (LAN) 1316. The chipset 1306 may include functionality for providing network connectivity through a network interface controller (NIC) 1322, such as a gigabit Ethernet adapter. A NIC 1322 may be capable of connecting the computing device 1300 to other computing nodes over a network 1316. It should be appreciated that multiple NICs 1322 may be present in the computing device 1300, connecting the computing device to other types of networks and remote computer systems.

The computing device 1300 may be connected to a mass storage device 1328 that provides non-volatile storage for the computer. The mass storage device 1328 may store system programs, application programs, other program modules, and data, which have been described in greater detail herein. The mass storage device 1328 may be connected to the computing device 1300 through a storage controller 1324 connected to the chipset 1306. The mass storage device 1328 may consist of one or more physical storage units. A storage controller 1324 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1300 may store data on a mass storage device 1328 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1328 is characterized as primary or secondary storage and the like.

For example, the computing device 1300 may store information to the mass storage device 1328 by issuing instructions through a storage controller 1324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1300 may further read information from the mass storage device 1328 by detecting the physical states or characteristics of one or more particular locations within the physical storage units.

In addition to the mass storage device 1328 described above, the computing device 1300 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1300.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1328 depicted in FIG. 13, may store an operating system utilized to control the operation of the computing device 1300. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1328 may store other system or application programs and data utilized by the computing device 1300.

The mass storage device 1328 or other computer-readable storage media may also be encoded with computer-executable instructions, which, when loaded into the computing device 1300, transforms the computing device from a general-purpose computing system into a special-purpose computer capable of implementing the aspects described herein. These computer-executable instructions transform the computing device 1300 by specifying how the CPU(s) 1304 transition between states, as described above. The computing device 1300 may have access to computer-readable storage media storing computer-executable instructions, which, when executed by the computing device 1300, may perform the methods described in relation to FIGS. 1-12.

A computing device, such as the computing device 1300 depicted in FIG. 13, may also include an input/output controller 1332 for receiving and processing input from a number of input devices, such as a keyboard, a mouse, a touchpad, a touch screen, an electronic stylus, or other type of input device. Similarly, an input/output controller 1332 may provide output to a display, such as a computer monitor, a flat-panel display, a digital projector, a printer, a plotter, or other type of output device. It will be appreciated that the computing device 1300 may not include all of the components shown in FIG. 13, may include other components that are not explicitly shown in FIG. 13, or may utilize an architecture completely different than that shown in FIG. 13.

As described herein, a computing device may be a physical computing device, such as the computing device 1300 of FIG. 13. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flow chart illustrations of methods, systems, apparatuses and computer program products. It will be understood that each block of the block diagrams and flow chart illustrations, and combinations of blocks in the block diagrams and flow chart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flow chart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flow chart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flow chart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
providing video content to a video rendering component of a user device;
receiving, by a first server device from a second server device, context information associated with objects displayed in a current view of the video, wherein the context information comprises one or more actionable commands associated with one or more of the objects and resource identifiers corresponding to the actionable commands;
receiving, by the first server device and from the user device, audio data indicative of user input; and
determining, by the first server device, and based on a comparison between the data indicative of user input and the one or more actionable commands, an actionable command of the one or more actionable commands.

2. The method of claim 1, wherein the context information comprises an indication of a subset of objects in the current view of the video that are determined to be executable.

3. The method of claim 1, wherein the context information is specific to the current view output via the video rendering component.

4. The method of claim 1, wherein the second server device comprises an application service located external to the user device.

5. The method of claim 1, wherein the determining the actionable command comprises translating the audio data to text information, and determining, based on the context information and the text information, the actionable command.

6. The method of claim 1, wherein the actionable command comprises a command to one or more of access content indicated on the video rendering component, navigate from the object to an additional object, activate the object, or navigate from one view of the video rendering component to an additional view of the video rendering component.

7. The method of claim 1, wherein the object comprises one or more of a button, plugin, a link, a graphic, a label, a list element, a table element, or a text element.

8. A method comprising:
providing video content to a video rendering component;
determining context information associated with objects displayed in a current view of the video, wherein the context information comprises one or more actionable commands associated with one or more of the objects and resource identifiers corresponding to the actionable commands;
receiving audio data indicative of user input associated with the interface;
sending, to a computing device, the context information and the audio data, wherein the computing device is configured to determine, based on a comparison between the data indicative of user input and the one or more actionable commands, an actionable command of the one or more actionable commands; and
receiving, based on sending the context information and the audio data, data associated with executing the actionable command.

9. The method of claim 8, wherein determining the context information comprises determining a subset of objects of the current view of the video that are executable, and wherein the computing device is configured to compare data indicative of the subset of objects to a text translation of the audio data to determine the actionable command.

10. The method of claim 8, wherein the context information is specific to the current view output via the video rendering component.

11. The method of claim 8, wherein determining the context information comprises receiving the context information from one or more of a user device outputting the video rendering component or an application service located external to the user device.

12. The method of claim 8, wherein the actionable command is determined based on translating the audio data to text information, and determining, based on the context information and the text information, the actionable command.

13. The method of claim 8, wherein the actionable command comprises a command to one or more of access content indicated on the video rendering component, navigate from the object to an additional object, activate the object, or navigate from one view of the video rendering component to additional view of the video rendering component.

14. The method of claim 8, wherein the object comprises one or more of a button, plugin, a link, a graphic, a label, a list element, a table element, or a text element.

15. A method comprising:
providing video content to a video rendering component of a user device;
storing, based on navigation by a user of the video rendering component, context information associated with objects displayed in a current view of the video, wherein the context information comprises one or more actionable commands associated with one or more of the objects and resource identifiers corresponding to the actionable commands;
sending, to an audio processing service, the context information;
receiving, from the audio processing service and based on the context information, an actionable command of the one or more actionable commands, wherein the audio processing service is configured to determine, based on a comparison of data indicative of user input and the one or more actionable commands, the actionable command; and
causing, based on receiving the actionable command, the video rendering component to execute the command.

16. The method of claim 15, wherein the context information comprises a subset of objects in the current view of the video that are executable.

17. The method of claim 15, wherein the context information is specific to the current view output via the video rendering component.

18. The method of claim 15, wherein storing the context information comprises one or more of tracking interactions of the user with the video rendering component, storing current state of the video rendering component, or storing changes to the video rendering component.

19. The method of claim 15, wherein the audio processing service is configured to translate audio data to text information, and determine, based on the context information and the text information, the actionable command.

20. The method of claim 15, wherein the actionable command comprises a command to one or more of access content indicated on the video rendering component, navigate from the object to an additional object, activate the object, or navigate from one view of the video rendering component to additional view of the video rendering component.
